(19) United States
(12) Patent Application Publication
(10) Pub. No.: US 2009/0006964 A1
(43) Pub. Date: Jan. 1, 2009

(54) INFORMATION PROCESSING APPARATUS AND CONTROL METHOD OF THE SAME

(75) Inventors: Yoshinori Honda, Nishitama-gun (JP); Shinichi Fukuda, Ome-shi (JP); Hiroki Miyata, Ome-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 12/145,956

(22) Filed: Jun. 25, 2008

(30) Foreign Application Priority Data
Jun. 29, 2007 (JP) 2007-173323

(51) Int. Cl. G06F 3/048

(52) U.S. Cl. 715/719

(57) ABSTRACT

According to one embodiment, an apparatus includes a receiving unit which receives a command according to pushing of a predetermined button of the buttons, a control unit which, if the command is received by the receiving unit, waits for a predetermined period before an operation corresponding to the command and controls an operation other than the operation corresponding to the command in accordance with a count of the command received during the period, and a display unit which displays a reproduction condition of the multimedia data controlled by the control unit.

### CROSS-REFERENCE TO RELATED APPLICATIONS

This application is based upon and claims the benefit of priority from Japanese Patent Application No. 2007-173323, filed Jun. 29, 2007, the entire contents of which are incorporated herein by reference.

### BACKGROUND

1. Field

One embodiment of the present invention relates to an information processing apparatus such as a personal computer and, more particularly, to an information processing apparatus having a function of facilitating control of multimedia data by a speech receiving apparatus connected therewith, and a control method of the information processing apparatus.

2. Description of the Related Art

In general, a device such as a personal computer, an HDD recorder or the like configured to reproduce multimedia data (speech data, moving image data) has a remote controller which performs an operation of easily reproducing the multimedia data. For example, Jpn. Pat. Appln. KOKAI Publication No. 2005-293408 discloses a technique of discriminating patterns of commands wirelessly transmitted by user's operations and performing a preliminarily registered operation upon receiving a predetermined command pattern.

According to the technique of Jpn. Pat. Appln. KOKAI Publication No. 2005-293408, however, the received rhythm pattern is discriminated by not the operated input signal, but commands wirelessly transmitted by user's operations. For this reason, a function command intended by the user may not be carried out by making a mistake in the operation of the rhythm pattern.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view showing appearance of a headphone and a computer according to an embodiment of the present invention;

FIG. 2 is an exemplary block diagram showing a system configuration of the computer according to the embodiment of the present invention;

FIG. 3 is an exemplary block diagram showing a configuration of software functions of the computer according to the embodiment;

FIG. 4 is an exemplary flowchart of a control method related with the computer according to the embodiment;

FIG. 5 is an exemplary table showing correspondence of command receiving patterns to allocation commands; and

FIG. 6 is an exemplary illustration showing a popup message.

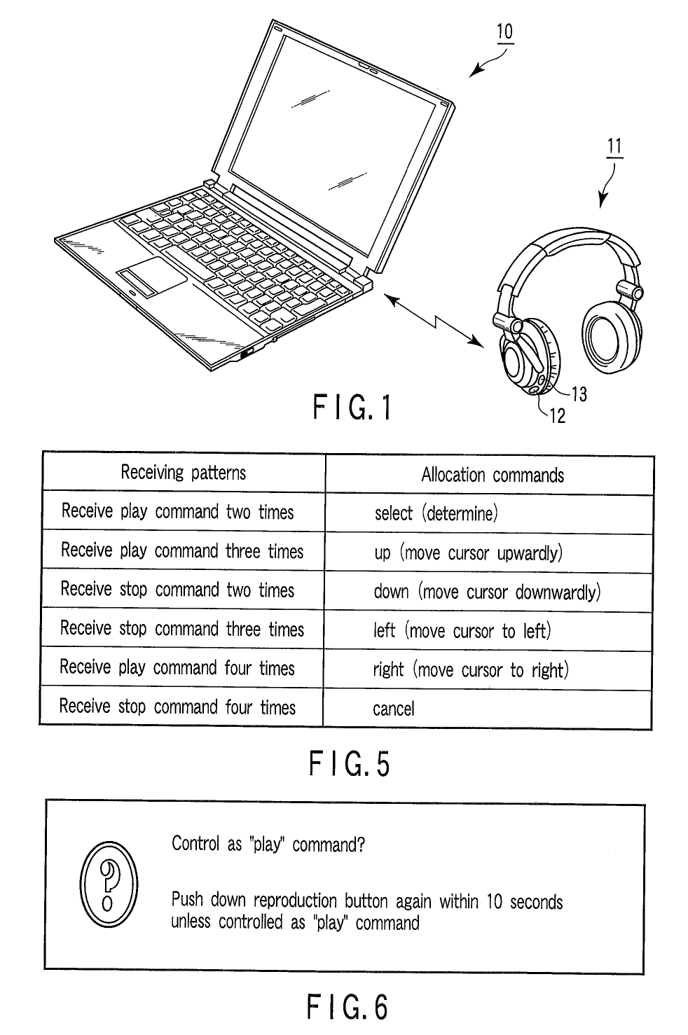

### DETAILED DESCRIPTION

Various embodiments according to the invention will be described hereinafter with reference to the accompanying drawings. In general, according to one embodiment of the invention, an information processing apparatus reproducing multimedia data and transmitting the reproduced multimedia data to a speech receiving device, the device includes buttons corresponding to respective operations concerning the reproduction of the multimedia data. The apparatus comprises a receiving unit which receives a command according to pushing of a predetermined button of the buttons; a control unit which, if the command is received by the receiving unit, waits for a predetermined period before an operation corresponding to the command and controls an operation other than the operation corresponding to the command in accordance with a count of the command received during the period; and a display unit which displays a reproduction condition of the multimedia data controlled by the control unit.

An embodiment of the present invention will be described below with reference to the accompanying drawings.

First, configuration of an information processing apparatus according to the embodiment of the present invention and a headphone device (speech receiving apparatus) is described. The information processing apparatus is implemented as, for example, a notebook-type personal computer (hereinafter called “computer”) 10. The information processing apparatus may be an apparatus capable of reproducing a moving image such as an HDD recorder or the like but is not limited to this.

The computer 10 can be connected to a headphone device 11 by radio connection such as Bluetooth®. The headphone device 11 comprises at least a reproduction button (generating a Play command by pushing down) 12, a stop button (generating a Stop button by pushing down: corresponding to operations relating to the reproduction of the multimedia data) 13, and the like. The headphone device 11 may also comprise a skip button to skip to previous or subsequent song, or the like.

Transmission and reception of the command information between the computer 10 and the controller such as the headphone device 11 having a remote control function are performed by a process based on a protocol and profile of AVCTP (Audio/Video Control Transport Protocol) and AVRCP (Audio/Video Remote Control Protocol) employing, for example, Bluetooth® using 2.45 GHz band radio waves. On the computer 10 side, the reproducing application of music and image contents is controlled in accordance with the command information received from the controller.

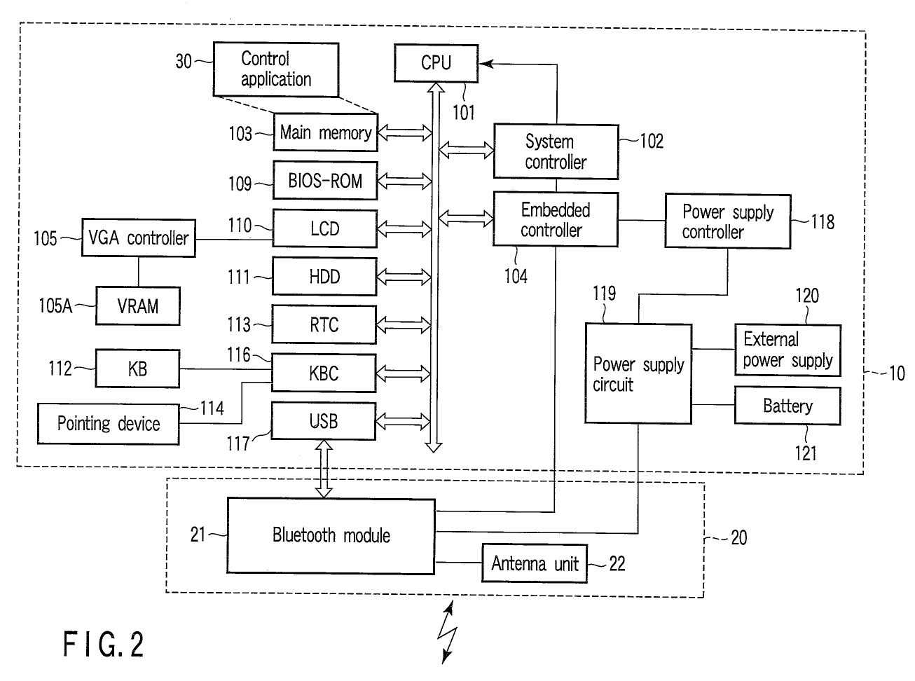

Next, a system configuration of the computer 10 is described with reference to FIG. 2.

As shown in FIG. 2, the computer 10 comprises a CPU 101, a system controller 102, a main memory 103, an embedded controller 104, a VGA controller 105, a video memory (VRAM) 105A, a BIOS-ROM 109, an LCD 110, a hard disk drive (HDD) 111, a keyboard 112, an RTC (Real Time Clock) 113, a keyboard controller IC (KBC) 116, a USB interface 117, a power supply controller 118, a power supply circuit 119, an external power supply 120, a battery 121, radio module 20, and the like. The radio module 20 comprises a Bluetooth® module 21 and an antenna 22.

The CPU 101 is a processor controlling the operations of the computer 10. The CPU 101 executes the operating system, a control operation 30 and the like loaded on the main memory 103 from the hard disk drive (HDD) 111. The CPU 101 also executes the BIOS (Basic Input Output System) stored in the BIOS-ROM 109. The BIOS is a program for the hardware control.

The VGA controller 105 is a display controller which controls the LCD 110 employed as a display monitor of the computer 10. A display signal generated by the VGA controller is supplied to the LCD 110.

The keyboard controller IC (KBC) 116 is a one-chip microcomputer on which an embedded controller for power supply management, and a keyboard controller for controlling the keyboard (KB) 112, a pointing device 114 and the like are integrated. The keyboard controller IC (KBC) 116 has a function of executing power-on/power-off of the computer 10, in accordance with the user's operation of the power button.

The radio module 20 performs transmission and reception of the multimedia and the control command with the headphone device 11 via the Bluetooth® module 21 and the antenna 22.

The Bluetooth® module 21 comprises a RF unit, a Baseband unit, a memory unit, a crystal oscillation unit and the like (to be described later). The headphone device 12 is also equipped with the same units. The computer 10 and the radio module 20 are connected by, for example, the USB interface 117. Besides the USB interface, an interface such as a PC card (PCMCIA, etc.), PCI or the like can be employed for the connection. In this case, a driver for each interface is required.

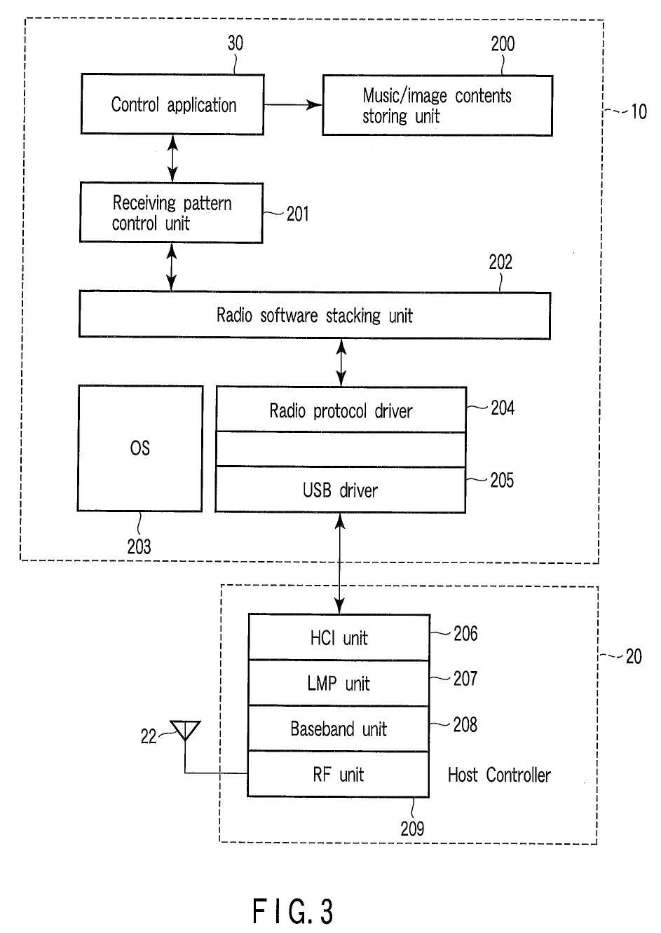

FIG. 3 is a block diagram showing a software configuration of the computer.

The main body of the computer 10 comprises a control application 30, a music/image contents storing unit 200, a receiving pattern control unit 201, a radio software stacking unit 202, an OS (operating system) 203, a radio protocol driver 204, a USB driver 205, and the like.

The radio module 20 comprises an HCI (Host Control Interface) unit 206, an LMP (Link Management Protocol) unit 207, a Baseband unit 208, an RF unit 209, the antenna 22, and the like.

The control application 30 executes a command processed by the receiving pattern control unit 201. The music/image contents storing unit 200 stores the music/image contents to be reproduced under the command received from the headphone 12. The receiving pattern control unit 201 processes the command received from the headphone 12 and the radio software stacking unit 202 executes transmission and reception processes of the command from the headphone 12.

The HCI unit 206 establishes communications with the radio module 20. The LMP unit 207 controls a radio link.

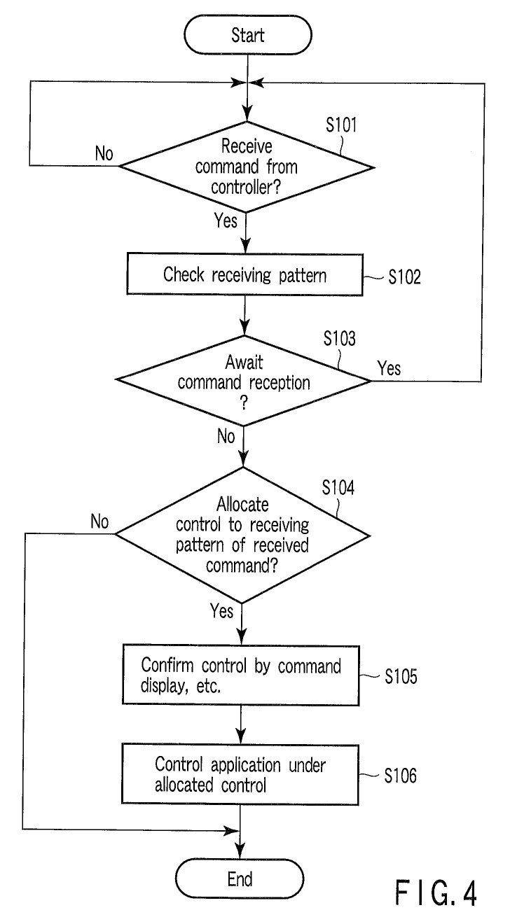

Next, a control method employing the information processing apparatus according to the embodiment of the present invention is described with reference to a flowchart of FIG. 4. The information processing apparatus according to the embodiment stands by for a predetermined period before shifting to an operation corresponding to the command, and executes an operation (for example, process of moving the pointing cursor) other than the operation (for example, reproducing process) corresponding to the command in accordance with the count of the commend received during the period. The command is a command based on the protocol defined by the AVCTP and AVRCP.

First, a command receiving pattern table is created. As shown in FIG. 5, for example, a receiving pattern of a received command and a command corresponding thereto are defined. It is checked whether a receiving pattern of the command reception matches the defined receiving pattern. If the receiving pattern of the command reception matches the defined receiving pattern, the command allocated thereto is controlled.

If the receiving pattern is “receive “play” command at two times within a second” (as generated by pushing down the reproduction button 12 at two times), the allocated command is “select: determine (control of an operation relating to a direction of selecting the command)”. If the receiving pattern is “receive “play” command at three times within a second”, the allocated command is “up: move pointing cursor (hereinafter called “cursor”) upwardly”. If the receiving pattern is “receive “stop” command at two times within a second” (as generated by pushing down the stop button 13 at two times), the allocated command is “down: move cursor downwardly”. If the receiving pattern is receive “stop” command at three times within a second”, the allocated command is “left: move cursor to the left”. The command wait time is set to one second, but is not limited to this.

The CPU 101 of the computer 10 loads the control application 30 to the main memory 103. The control application 30 checks the command reception from the headphone 11 (block S101). If it is discriminated by the control application 30 that the command from the headphone 11 has been received (YES in block S101), the receiving pattern of the command is checked by the receiving pattern control unit 201 (block S102). Checking the receiving pattern of the command is executed by using, for example, a table as shown in FIG. 5. For example, if “receive Play command at two times” is executed, awaiting reception of the command (for example, elapse of one second) is discriminated by the receiving pattern control unit 201 (block S103). If it is discriminated by the receiving pattern control unit 201 that one second has elapsed (NO in block S103), it is checked by the receiving pattern control unit 201 whether allocation of a control method to the receiving pattern has been determined as a result of the checking (block S104).

If the allocation of the control method to the receiving pattern is determined by the receiving pattern control unit 201 (YES in block S104), the command name or a confirmation message is displayed on the LCD 110 serving as the display device such that the user can confirm the command reception (block S105).

The control application 30 controls the music/image contents reproducing application in the allocated control method (block S106). For example, if “receive Play command at two times” is executed, the allocation is determined and the selected music file (multimedia data) or the like is reproduced.

In block S103, for example, if “receive Play command at two times” is executed and it is discriminated by the receiving pattern control unit 201 that one second does not elapse (YES in block S103), a predetermined period (one second) is further awaited. If “receive Play command at one time” is executed during this period, it is assumed that “receive Play command at three times” is executed during the predetermined period of one second, and the allocated control is “up” (move the cursor upwardly).

In the embodiment, it is assumed that the user operates under the conditions that the user cannot see the buttons (reproduction button 12, stop button 13, and the like) of the headphone device 11. For this reason, a function of guiding operations from the command reception to determination of the control which the user intends may be added. For example, when the reproduction button 12 of the headphone device 11 is pushed down, a popup is displayed as shown in, for example, FIG. 6 and it can be selected whether or not the control for the receive command can be determined as “play”. If the control for the receive command is not determined (if the reproduction button 12 is pushed down within ten seconds), it can be selected whether the control for the receive command can be determined as a next control candidate (for example, “select”). This operation is repeated until the user determines the control.

According to the embodiment, the user can easily execute the function command which the user intends, by employing the pattern using the receiving count and combination of the commands. Even if the headphone device has a small number of operation buttons, operability is enhanced since the controllable operation variation is increased by the button operation pattern. Moreover, usability can also be enhanced if the definition of the receiving pattern can be customized by the user. In addition, a means for guiding the operations up to determination of the control which the user intends is provided by the receiving command. Thus, even if the controller has a small number of operation buttons, the operability is enhanced since variation of the controllable operations can be increased.

The present invention is not limited to the embodiments described above but the constituent elements of the invention can be modified in various manners without departing from the spirit and scope of the invention. Various aspects of the invention can also be extracted from any appropriate combination of a plurality of constituent elements disclosed in the embodiments. Some constituent elements may be deleted in all of the constituent elements disclosed in the embodiments. The constituent elements described in different embodiments may be combined arbitrarily.

The object of the present invention is to provide an information processing apparatus and a control method, capable of easily executing a function command intended by the user.

Advantages of the invention will be set forth in the description which follows, and in part will be obvious from the description, or may be learned by practice of the invention. Advantages of the invention may be realized and obtained by means of the instrumentalities and combinations particularly pointed out hereinafter.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus reproducing multimedia data and transmitting the reproduced multimedia data to a speech receiving device, the device comprising buttons corresponding to respective operations concerning the reproduction of the multimedia data,
the apparatus comprising:
a receiving unit which receives a command according to pushing of a predetermined button of the buttons;
a control unit which, if the command is received by the receiving unit, waits for a predetermined period before an operation corresponding to the command and controls an operation other than the operation corresponding to the command in accordance with a count of the command received during the period; and
a display unit which displays a reproduction condition of the multimedia data controlled by the control unit.

2. The apparatus according to claim 1, wherein the buttons are at least a reproduction button and a stop button.

3. The apparatus according to claim 1, wherein the control is a control of at least operations concerning a command selecting direction and a movement of a pointing cursor displayed on the display unit.

4. The apparatus according to claim 1, wherein the command is a command based on a protocol defined by AVCTP and AVRCP.

5. A control method employed in an information processing apparatus reproducing multimedia data and transmitting the reproduced multimedia data to a speech receiving device, the device comprising buttons corresponding to respective operations concerning the reproduction of the multimedia data,
the method comprising:
receiving a command according to pushing of a predetermined button of the buttons; and
if the command is received, waiting for a predetermined period before an operation corresponding to the command, controlling an operation other than the operation corresponding to the command in accordance with a count of the command received during the period, and displaying a reproduction condition of the multimedia data controlled by the control unit.

6. The method according to claim 5, wherein the buttons are at least a reproduction button and a stop button.

7. The method according to claim 5, wherein the control is a control of at least operations concerning a command selecting direction and a movement of a pointing cursor displayed on the display unit.

8. The method according to claim 5, wherein the command is a command based on a protocol defined by AVCTP and AVRCP.
